(19) United States
(12) Patent Application Publication
(10) Pub. No.: US 2008/0063261 A1
(43) Pub. Date: Mar. 13, 2008

(54) OBJECTIVE EVALUATION OF FABRIC PILLING USING STEREOVISION AND MEASURING APPARATUS

(75) Inventor: Tae-Jin KANG, Seoul (KR)

Correspondence Address: CANTOR COLBURN, LLP, 20 Church Street, 22nd Floor, Hartford, CT, 06103, US

(73) Assignee: SEOUL NATIONAL UNIVERSITY INDUSTRY FOUNDATION, Seoul (KR)

(21) Appl. No.: 11/939,822

(22) Filed: Nov. 14, 2007

Related U.S. Application Data
(63) Continuation of application No. 10/758,868, filed on Jan. 16, 2004.

(30) Foreign Application Priority Data
Oct. 29, 2003 (KR) 10-2003-0075709

(51) Int. Cl. G06K 9/00

(52) U.S. Cl. 382/154

(57) ABSTRACT

The present invention relates to a objective measurement of fabric pillings, to a measurement apparatus which includes stereovision technique using CCD cameras, captures the 3-dimensional contours of fabric pilling and defines the degree of pilling occurrences. This invention is composed of; a step to scan the surface of a pilling-containing fabric specimen which is laid on the table and translated in the right angle of the projector laser beam; a step to reconstruct the scanned fabric surface data in to a 3D image; a step to convert the 3D image into a binary image using height-threshold method and number, area, density of pillings acquired from standard pictures; a step to calculate the x, y coordinates and height values of each and every area of the specimen; a step to regress the relationship between the height values of the pilling fabric specimen and the actual height values. Thus the measurement of fabric surface pillings using stereovision method which is composed of slit beam laser projector and a couple of CCD cameras can be a fast and accurate evaluation method regardless of the fabric's color and pattern shape.

### CROSS REFERENCE TO RELATED APPLICATIONS

This application is a continuation of U.S. patent application Ser. No. 10/758,868, filed on Jan. 16, 2004, which claims priority to Korean Application No. 10-2003-0075709, filed on Oct. 29, 2003, the disclosure of which are herein incorporated by reference in their entirety.

### BACKGROUND OF THE INVENTION

1. Field of the Invention

The present invention relates to fabric pillings, more particularly, to measurement method and apparatus to acquire and evaluate the degree of fabric pilling occurrences using stereovision technique by using slit beam laser projector and CCD cameras.

2. Background of the Related Art

The pillings take place in the surface of the fabrics when they are manufactured to product form of garments, making serious problems in aesthetic view and fabric structures.

Briefly speaking of pilling phenomenon, some of the fabric surface yarns are cut by friction forming fluffs and are entangled at the surface in spherical shape. A pill is named in the case of cotton yarn, whereas the term ‘snag’ is used in the case of filament yarns.

Pills occur more often in the synthetic fibers than in the natural fibers, and their presence degrades the visual and tactile senses and blocks both the material design and the product design.

Moreover, pillings are the resultant effect of various properties including materials properties and finishing treatment of fibers and yarns. Some fluffs emerge from the fabric surface when fibers within external yarns are broken, then the fluffs are entangled due to friction and they form a pill that is attached to the fabric surface by one or more fibers.

Accordingly, there are needs for the objective evaluation method of pilling occurrences because pillings are result of fiber properties, fabric structure and finishing treatment of the fabrics and thereby represent the fabric quality.

As an example, image processing techniques which use standard pilling photographs were used widely.

Those techniques are basically applicable only for monochromatic 2D images, therefore suitable for only fabrics of simple color and pattern, and not for those of diverse colors and complex shapes.

A method using laser surface profiler which captures surface depth data regardless of fabric color and pattern was devised, but it took too long time to measure the small area of a fabric.

### SUMMARY OF THE INVENTION

Therefore, the present invention has been made in view of the above problems, and it is an object of the present invention to provide the measurement and apparatus of fabric pillings using slit beam laser and CCD cameras scanning the wide area in fast time regardless of the fabric color and patterns.

In order to achieve the above-described objects of the present invention, the pilling measurement method and apparatus using stereovision have the characteristic steps of the following; a step to scan the surface of a pilling-containing fabric specimen which is laid on the table and translated in the right angle of the projector laser beam; a step to reconstruct the scanned fabric surface data in to a 3D image; a step to convert the 3D image into a binary image using height-threshold method and number, area, density of pillings acquired from standard pictures; a step to calculate the x, y coordinates and height values of each and every area of the specimen; a step to regress the relationship between the height values of the pilling fabric specimen and the actual height values.

Before the measurement of the fabric pilling starts, it is preferred to calibrate the initial position of the apparatus.

The initial calibration is done using the calibration blocks and regression is performed between pixel shift and actual height values. The regression gave linear regression coefficient higher than 0.99.

And the apparatus is composed of; a horizontally traveling table where the fabric specimen is laid and fixed a slit beam laser projector which emits laser in the right direction of the table and measures the surface height of the specimen; a coule of CCD cameras which is fixed slanted by a certain degree to the laser projector and captures the surface profile of the fabric specimen; a controller that receives the data from CCD cameras and controls the movement of the slip beam laser projector and horizontally traveling table.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1a illustrates the photographic pilling standards of ASTM 3512,

FIG. 1b illustrates binary images of FIG. 1a,

FIG. 2a illustrates the relationship between standard pilling specimen of each level and the number of pilings,

FIG. 2b illustrates the graph of standard pilling specimen of each level versus the area of pilings,

FIG. 2c illustrates the graph of standard pilling specimen of each level versus the density of pilings,

FIG. 3 illustrates the graph of height versus area of pilings,

FIG. 4 illustrates the schematic view of the pilling measurement system using stereovision technique,

FIG. 5 illustrates the sample specimen with pilings,

FIG. 6 illustrates a brief view of 3D image of a pilling containing fabric acquired using pilling measurement apparatus,

FIG. 7 illustrates the calibration blocks to calibrate the initial position of the apparatus,

FIG. 8a illustrates the relationship between pixel shift and actual height,

FIG. 8b illustrates the shifted laser beam image due to the difference in specimen height.

### DETAILED DESCRIPTION OF THE PREFERRED EMBODIMENT

Reference will now be made in detail to the preferred embodiments of the present invention, examples of which are illustrated in the accompanying drawings.

First, the theoretical explanation of the present invention is given before description of the herein measurement method and apparatus.

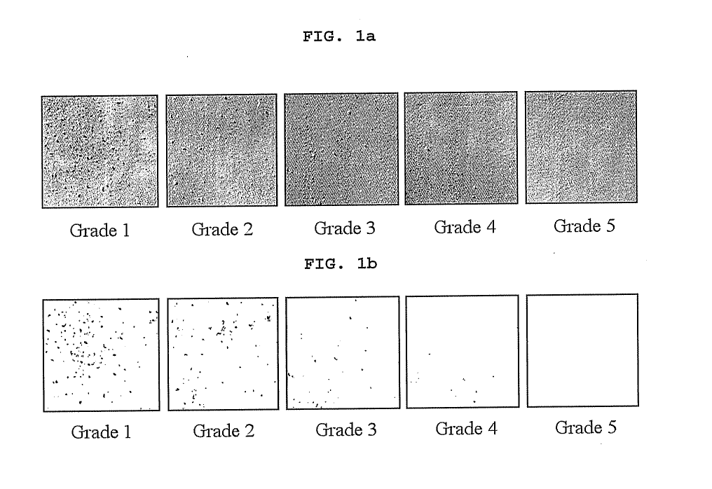

FIG. 1a illustrates images of ASTM 3512 standard photographs, while 1b shows the binary images of those photographs.

By applying the histogram equalization function which is one the common image processing techniques with certain threshold value, the binary images shown as FIG. 1b is acquired.

The actual dimension of the standard photograph can be represented by the number, area and density of the pillings that are black pixels in the binary image.

TABLE 1

| | Number of Pills | Area of Pills | Pill Density |
|---|---|---|---|
| Grade 1 | 128 | 19.5 | 0.707 |
| Grade 2 | 68 | 9.61 | 0.31 |
| Grade 3 | 35 | 4.84 | 0.16 |
| Grade 4 | 11 | 2.16 | 0.07 |
| Grade 5 | 0 | 0 | 0 |

The correlation between number, area and density of pills are given in the following.

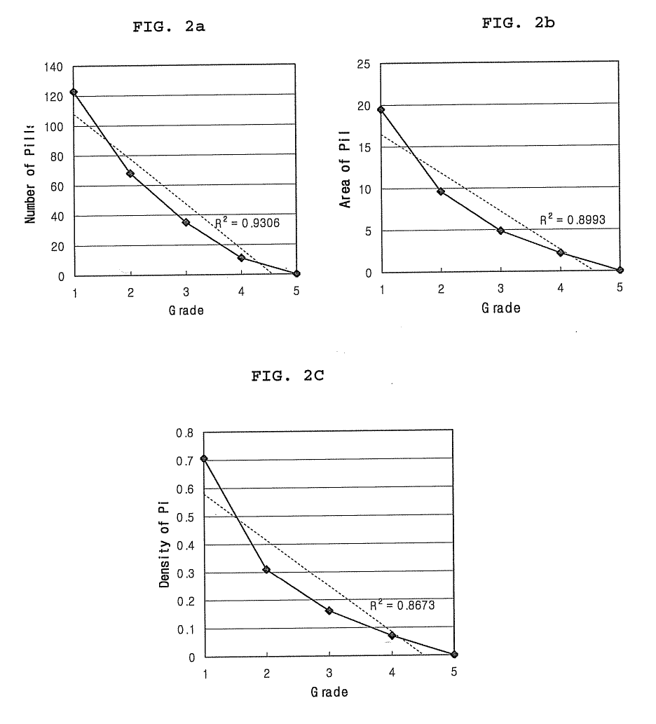

FIG. 2a shows the graphs of number of pillings versus standard photographs of each level.

FIG. 2b shows the graphs of area of pillings versus standard photographs of each level.

FIG. 2c shows the graphs of density of pillings versus standard photographs of each level.

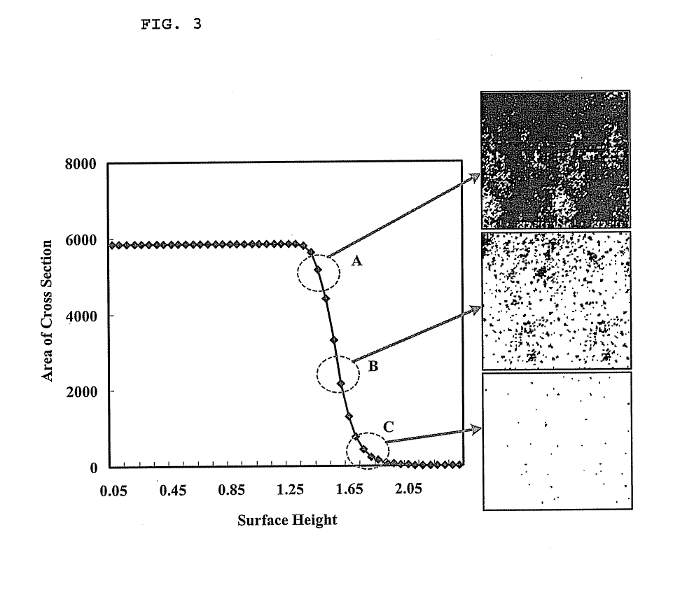

FIG. 3 shows the graphs of heights of pillings versus cross-sectional area of pillings.

The relationships between degree of pillings, number, area, and density of pillings can be depicted as FIGS. 2a and 2c. Their regression gives linear regression coefficient value above 0.90.

Therefore, the equation to calculate the degree of pillings from number, area, and density of pillings can be derived from the multi variable linear regression of the following;
Degree of Pillings
=40172−0.018×Number−1.017×Area+24.834×Density

Number (N)=Number of pillings

Area (A)=Area of pillings

$$Density ( D ) = Poly \text{-} dispersity = \frac{N}{{\sum }_{i} {γ}_{i}^{2}} \qquad ( 1 )$$

The measurement of pillings is done from the measurement of number, area, and density of pillings. And those values are used for both statistical analysis and image analysis to specify the characteristics of the fabric specimen comparing the standard photographs.

There are linear relationships between number, area, density of pillings shown as FIGS. 2a and 2c. So the objective evaluation of pillings is possible from measuring the pilling number, area and density of the standard photographs.

And those number, area and density values are evaluated from the 3D surface profiles of the pilling containing fabric using stereovision technique.

The 3D surface profile is captured using height-threshold method to extract the pillings from the fabric surface. The 3D surface data is converted to binary image by height-threshold algorithm and number, area and density of the specimen calculated from the image.

The height-threshold method implies that those areas whose height values are not different from pre-determined threshold are considered to be the part of the fabric while those with height values larger than the threshold are considered to be pillings.

Therefore, the binary image is acquired from the 3D data by representing fabrics as white and pillings as white.

The threshold value is determined by analyzing the graph showing the height value versus areas positioning higher than certain height value. The height values within the dotted circle is proper for the pilling subtraction. The 3D surface data is converted to binary image using height-threshold method and the pilling parameters are showed as the standard photograph as stated above.

The degree of pillings can be determined from number, area and density of the pillings calculated from the 3D surface profile data and regression of the manual assessment. Thus the degree of pillings in the standard photographs can be inferred from the regression.

The followings are the description of the apparatus of the present invention using stereovision.

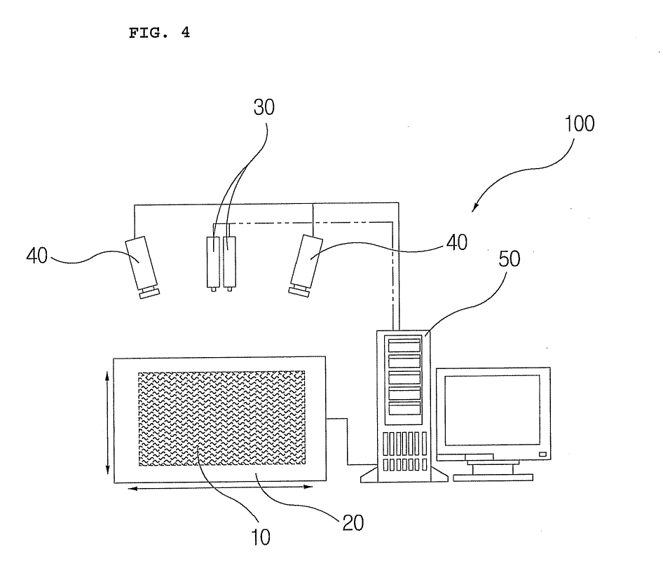

FIG. 4 illustrates the diagram of the apparatus using stereovision.

As shown in FIG. 4, the pilling evaluation apparatus (100) is composed of the following components; a slit laser beam projector (30) which measures the surface height of the specimen; a couple of CCD cameras (4) lying in the both side of the slit laser beam projector (30) to scan the surface profile of the fabric specimen in 3D; a horizontally traveling table (20); a controlling personal computer (50) which receives data and calculates the pilling information.

The pilling evaluation apparatus (100) using stereovision is developed especially for the assessment of fabric pilling properties, and those systems including the present invention can be used for specimens of diverse color and pattern in relative short time.

The followings are the detailed description of the measurement of the present invention using stereovision.

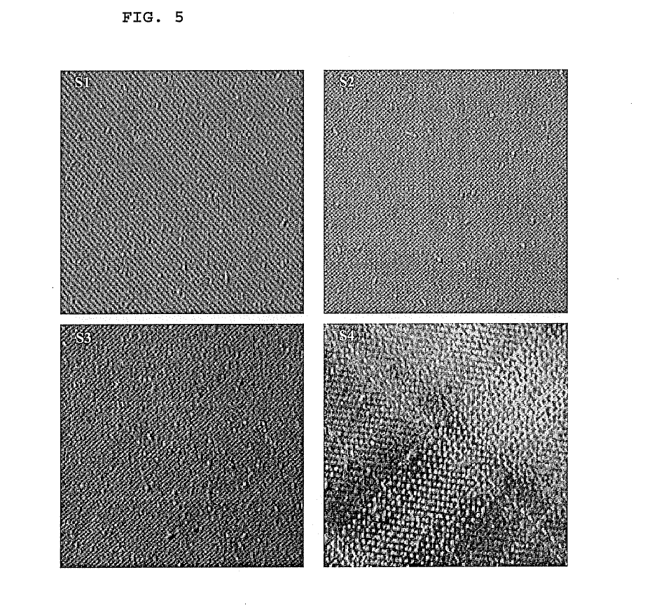

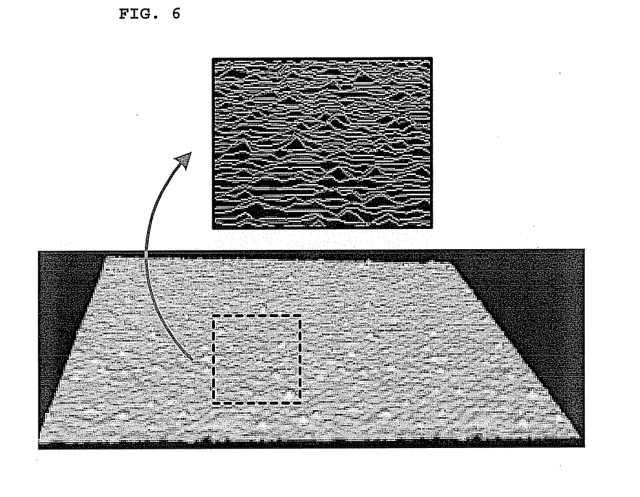

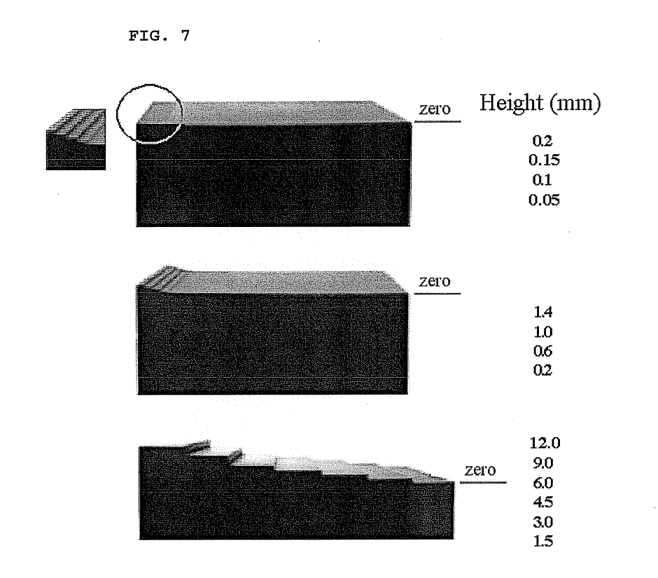

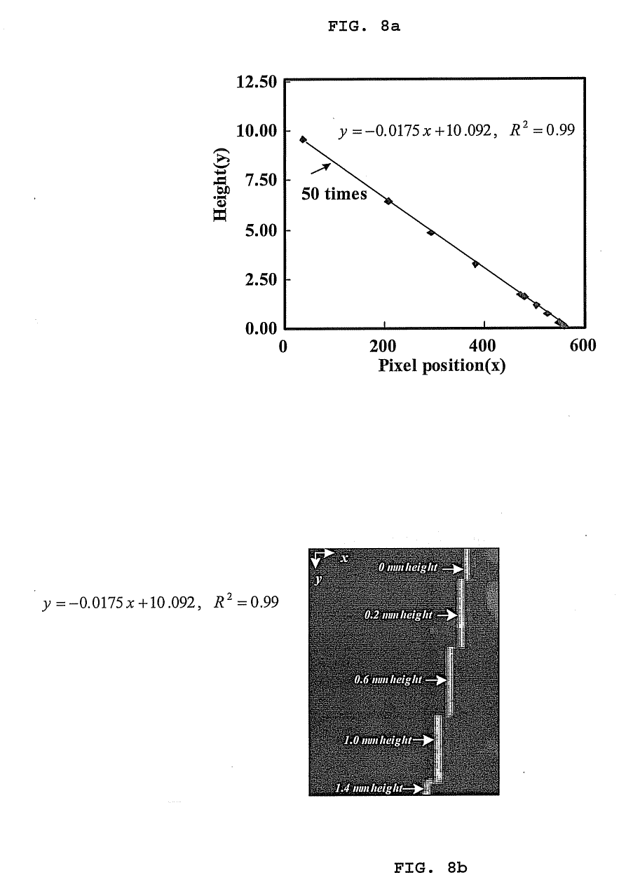

FIG. 5 illustrates the sample specimens of the pilling containing fabrics. FIG. 6 illustrates the schematic diagram of the apparatus. FIG. 7 illustrates the calibration blocks to adjust the initial position of the apparatus. FIG. 8a shows the graph of pixel shift of the apparatus versus actual height values. FIG. 8b shows the image of laser beam shifted by the height differences.

First, the fabric specimen (10) containing pillings is laid on the horizontally traveling table (20) and the table (20) is translated horizontally in the right angle of the slit laser beam projector (30), where the CCD cameras (40) and slit laser beam projector (30) are not parallel so the captured laser beam profiles represents the surface profiles of the specimen (10).

Therefore, the 3D image is reconstructed by analyzing the profiles of laser beam over the whole range of the specimen.

The 3D surface profile data of the specimen (10) is converted to the binary image using height-threshold algorithm and number, area and density of pillings calculated.

And the position of certain region of the specimen (10) is calculated from the position of the horizontally traveling table (20) and the height value is acquired to reconstruct the 3D fabric image.

As stated above, if the surface of the fabric specimen (10) is rough, the captured lines of laser beam is not straight and the amount pixel shift shows the distance between the original line and the shifted line by the surface roughness.

Furthermore, the actual height value of a certain region of the specimen (10) is calculated from the pixel shift and it is necessary to calibrate the initial position of the apparatus (100) and correlate the pixel shifts with the real height values.

The initial calibration of the pilling evaluation apparatus (100) is done with 3 different kind of calibration blocks. The maximum error is 0.1 m shown as FIG. 8a and the correlation between pixel shift and actual height values are shown in FIG. 8b. As the figures show, it is desirable to regress the pixel shifts with the actual height values. The linear regression gives regression coefficient about 0.99.

### EXAMPLE

In the present invention, the area of measurement is 80×80 mm and the 3D surface profile is converted to binary image of 480×480 pixels. The number of pillings is calculated from the number of black pixels by 8-connectivity algorithm and the density of the pillings is the ratio of the number of pillings over the mean distances of the pillings.

The sample specimens with the size of 80×80 mm were measured at 0.5 mm intervals in both x and y directions. The result of S12 sample can be a reference to compare with the fabric of no pillings as shown in FIGS. 9a and 9b. The TABLE 2 shows the number, area, density and grade of pillings for each sample.

TABLE 2
MEASUREMENT OF PILINGS FOR FABRIC SAMPLES

| Sample | | | | |
|---|---|---|---|---|
| code | Number of Pills | Area of Pills | Density of Pills | Pilling grade |
| S1 | 105 | 18.95 | 0.707 | 1.22 |
| S2 | 65 | 9.93 | 0.350 | 1.99 |
| S3 | 121 | 19.12 | 0.713 | 1.00 |
| S4 | 36 | 5.02 | 0.180 | 3.11 |

As set forth above, the present invention provides a method to evaluate the degree of fabric pillings regardless of the fabric color and pattern using stereo vision technique which measures the surface pillings by slit laser beam projector and a couple of CCD cameras.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method for evaluating fabric pillings with a stereovision procedure comprising the steps of:
laying a fabric specimen on a table which travels horizontally in the right angle of a projector laser beam located above the table for measuring a surface height of the pillings;
obtaining the surface profile of the fabric specimen with a couple of cameras inclined in both sides of the projector laser beam for re-constructing a three-dimensional (3D) image of the fabric specimen together with the height of the fabric specimen and converting the three dimensional (3D) image into a binary image using a height-threshold algorithm; and
grading the pilling of the fabric specimen from the binary image,
wherein the actual height of the fabric specimen at a certain position is calculated according to pixel shift of an apparatus for measuring the pilings of the fabric specimen after establishing the relationship between the pixel shifts and the actual height of the fabric specimen through adjustment of the initial calibration position of the apparatus, the adjustment is measured using three different kinds of calibration blocks, and the pixel shifts is linearly regressed with the actual height.

2. The method according to claim 1, wherein a coefficient for linear regression is 0.99.

3. An apparatus for evaluating fabric pillings in stereovision comprising:
a table which can be translated in a horizontal direction with a fabric specimen fixed for calculating an (x, y) position of the fabric specimen;
a slit laser beam projector located above the table for measuring a height of the fabric specimen;
a couple of charge coupled devices (CCD) placed in both sides of the slit laser beam for capturing a surface profile of the fabric specimen wherein each of the charge devices is laterally directed to each other; and
a personal computer for reconstructing the three dimensional (3D) image of the fabric specimen and converting the image into a binary image;
wherein an initial calibration position of the apparatus is adjusted using three different kinds of calibration blocks, the height of the fabric specimen is calculated by shift pixels of the apparatus through adjustment of the initial calibration position of the apparatus, and the shift pixels are linearly regressed according to a relationship between the actual heights and shift pixels.
